(19) United States
(12) Patent Application Publication
(10) Pub. No.: US 2024/0359310 A1
(43) Pub. Date: Oct. 31, 2024

(54) MOTORIZED LIFT APPARATUS AND ASSEMBLIES FOR BICYCLE REPAIR STAND

(71) Applicant: REMCO TOOLS LLC, Portland, OR (US)

(72) Inventors: Ryan Liverman, Portland, OR (US); Mathias Ellegiers, Portland, OR (US)

(73) Assignee: REMCO TOOLS LLC, Portland, OR (US)

(21) Appl. No.: 18/634,397

(22) Filed: Apr. 12, 2024

Related U.S. Application Data
(60) Provisional application No. 63/462,383, filed on Apr. 27, 2023.

(51) Int. Cl. B25H 1/00; B66F 3/10; B66F 3/44

(52) U.S. Cl. CPC B25H 1/0014; B66F 3/10; B66F 3/44; B66F 2700/12

(57) ABSTRACT

Motorized bicycle lift apparatus and assemblies and methods of use. The lift apparatus includes a telescopic column that can raise or lower the height of the bicycle supported thereon via a motorized linear actuator. The actuator is situated within telescoping sections that nest within one another as the lifting column extends and retracts. The bottom of the lifting column has a base mount that allows various base structures to attach to the lift, such as a support plate for a freestanding lift or another stand for a retrofit lift. On the top end of the column opposite the base mount, a universal clamp mount is provided to allow the stand to be used in combination with various bicycle clamps.

### CROSS-REFERENCE TO RELATED APPLICATIONS

This application claims the benefit of U.S. Provisional Patent Application No. 63/462,383, filed Apr. 27, 2023, which is incorporated by reference herein in its entirety.

### FIELD OF THE INVENTION

The present invention relates to motorized lift apparatus, assemblies, and methods, such as a lift apparatus for bicycle repair which can be used in combination with various bases and/or clamps.

### BACKGROUND

Bicycle repair stands have long been used by bicycle enthusiasts and mechanics to raise and lower the level of a bicycle as they work on various parts. For example, bicycle stands are used during bicycle assembly, maintenance and repair to allow the worker to lift the bicycle off of the ground in order to better access various parts of the bicycle. Existing bicycle stands include a base that rests on the ground or tabletop worksurface and a clamp that releasably connects to the bicycle such that the bicycle is lifted to a desired height when clamped thereto. Many stands have a fixed-height while others may include a base with a height adjustable mechanism that allows an operator to control the specific height as needed. The primary benefit of a height-adjustable bicycle stand is to allow operators to service increasingly heavy e-bicycles, cargo bicycles, and mountain bicycles at a comfortable and ergonomically appropriate height without requiring the bicycle to be physically lifted to that height by the mechanic. Although stands with lifts are therefore generally known, there remains a desire to those having an ordinary skill in the art to provide an improved motorized lift that can be retrofit to existing stands to provide additional functionality to the operator without requiring the operator to obtain an entirely new stand with a height adjustable base.

An example of a height-adjustable stand is described in US Pat. App. Pub. No. 2012/0007298 by Proietti. This stand includes a base with a telescoping column that can be adjusted to raise and lower the bicycle held by the clamp at the top of the column. Although the '298 stand by Proietti is designed to function with commercial clamps that hold the bicycle, the stand neither includes a motor to assist the operator with adjusting the height of the stand nor can be retrofit with existing fixed-height stand or base. Thus, there remains a need for an improved motorized lifting device that can be retrofit to existing stand with a fixed height or manually adjusted lifting column or base while still allowing operator to use commercially available clamps.

Motorized adjustable bicycle lifts are even more necessary as e-bicycles, which can weigh upwards of 70 pounds, become more mainstream. With the increased adoption of heavier e-bicycles, professional and amateur mechanics have to lift heavier bicycles in order to service them. Most current bicycle stands require either two people to lift and secure a bicycle in the stand or they place a significant physical stress on an individual mechanic. There is clearly a need for a better system to bring bicycles up to working height. For example, in the EU there are countries where bicycle mechanics are not allowed to lift bicycles over a certain weight. In addition, the National Institute Of Safety and Health (NIOSH) has a lifting equation for calculating a recommended weight limit for one person under different conditions. The lifting equation establishes a maximum load of 51 pounds, which is then adjusted to account for how often the lifter is lifting, twisting of their back during lifting, the vertical distance the load is lifted, the distance of the load from the lifter's body, the distance the lifter moves while lifting the load, and how easy it is to hold onto the load. This limit is low enough to exclude most e-bicycles on the market. Accordingly, there remains a need for a motorized bicycle lift device that can be retrofit with existing stands.

Although not particularly directed to a bicycle stand, U.S. Pat. No. 9,018,813 by Randløv and U.S. Pat. No. 11,284,709 by Lu et al. each describe motorized lifting columns with various telescoping sections and an internal motor. Although effective lifting column designs, these telescoping columns do not provide any modularity and cannot be readily retrofit within existing bicycle repair stands without changing their principle of operation and rendering them unfit for their intended purpose. Thus, there remains a need to provide a lift that integrates with a lifting device for a bicycle stand to provide motorized lift assist to users who previously used fixed-height stands.

### SUMMARY

The motorized bicycle lift apparatus, systems, and methods described herein includes a telescopic lifting column driven by a motorized spindle that can raise and lower a bicycle attached to a clamp on the end of the lift. The lift attaches to a base opposite from the clamp. The lift is universal and designed to work with industry standard repair stands such that the lift can be retrofit to a wide range of existing bicycle repair stands that do not necessarily have a motorized lifting column. The universally adaptable lift can therefore, in some examples, provide a lower cost solution to operators who do not already have a stand with a motorized lift, such as someone who has a fixed-height repair stand, because the motorized lift apparatus described can be integrated into their existing stand.

The lift apparatus includes a telescopic column that can raise or lower the height of the bicycle supported thereon via a motorized linear actuator. The actuator can be situated within telescoping segments that nest within one another as the lifting column retracts and are exposed from one another as the lifting column extends. To prevent debris, including, for example, solids such as dust and scrap metal as well as liquids and degreasers, from damaging the lifting column and actuator disposed therein, in some examples, the telescoping segments can be inverted such that the top-most segment has the largest cross section and receives each of the smaller lower segments. Accordingly, the open edges of the various sections are not exposed from above and debris is less likely to become lodged between the moving sections. In some examples, the telescoping segments can have a different arrangement or configuration, such as having a lower-most segment having the largest cross section that can receive each of the smaller upper segments when the lift column retracts.

The bottom of the lifting column has a base mount that allows various base structures to attach to the lift, such as a support plate for a freestanding lift or another stand for a retrofit lift. With this universal base mount, the improved motorized lift can be used alone or in combination with another stand. On the top end of the column opposite the base mount, a universal clamp mount is provided to allow the stand to be used in combination with any number of bicycle clamps.

In some examples, the actuator includes a gyroscopic collision sensor, or an alternative collision sensor, that detects when the lifting column hits another object and immediately stops extension to prevent damage. Furthermore, the actuator can be controlled with a remote handset to allow the user to stand clear of the moving lift.

Further areas of applicability of the apparatus, systems, and methods disclosed herein will become apparent from the detailed description. It should be understood that the detailed description and examples are intended for purposes of illustration and are not intended to limit the scope of the disclosure.

### BRIEF DESCRIPTION OF THE DRAWINGS

FIGS. 1A and 1B are respectively an isometric view and a side elevation view an exemplary lift apparatus in an extended position, in accordance with the present disclosure.

FIGS. 1C and 1D are respectively an isometric view and a side elevation view of the lift apparatus of FIGS. 1A and 1B in a retracted position.

FIGS. 2A, 2B, and 2C are respectively a front elevation view, a left elevation side view, a right elevation view of the lift apparatus of 1A-1D with the actuator cover removed.

FIG. 2D is a transparent isometric view of the lift apparatus of FIGS. 1A-2C.

FIGS. 3A-3D are isometric views of an exemplary base mount for the lift apparatus of FIGS. 1A-2D and an exemplary base for use with the lift apparatus of FIGS. 1A-2D.

FIGS. 4A-4D are isometric views of an exemplary clamp mount for the lift apparatus of FIGS. 1A-2D.

FIGS. 5A-5F are isometric views of exemplary bicycle clamps attached to the clamp mount of FIGS. 4A-4D for use with the lift apparatus of FIGS. 1A-2D.

FIGS. 6A and 6B are exploded views of a top end of an exemplary telescopic column for the lift apparatus of FIGS. 1A-2D with a top housing portion removed.

FIGS. 7A and 7B are front elevation views of an exemplary controller and handset for use with the lift apparatus of FIGS. 1A-2D.

### DETAILED DESCRIPTION

The following description of exemplary lift apparatus and assemblies and an exemplary methods of use is merely exemplary in nature and is in no way intended to limit the disclosure, application, or uses of the exemplary lift apparatus, assemblies, and methods.

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements unless the context clearly indicates otherwise.

The methods described herein should not be construed as limiting in any way. Instead, the present disclosure is directed toward all novel and non-obvious features and aspects of the present disclosure, alone and in various combinations and sub-combinations with one another. The disclosed methods are not limited to any specific aspect or feature or combinations thereof, nor do the disclosed methods require that any one or more specific advantages be present or problems be solved. Any theories of operation are to facilitate explanation, but the methods are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed devices and methods can be used in conjunction with other devices and methods. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art. Furthermore, examples may be described with reference to directions indicated as “above,” “below,” “upper,” “lower,” and the like. These terms are used for convenient description, but do not imply any particular spatial orientation unless so indicated. As used herein, “coupled” or “coupling” means a connection between two or more elements, whether direct or indirect, so long as the connection occurs.

The motorized lift apparatus for a bicycle repair stand and methods of use described herein are designed to assist people with lifting heavy bicycles and e-bicycles to a workable height. The mechanical assist provided by the motorized lift apparatus reduces likelihood of physical injuries by making it easier to lift heavy and cumbersome bicycles, thereby reducing accumulated stress on the person's body and/or acute injuries. One exemplary aspect of the invention is its universal modularity and ability to be retrofit with most existing repair stand clamp mechanisms and shop bases. As detailed below, the lift can be configured to work with existing component standards in the bicycle industry. This construction does not require users to buy into a particular tool ecosystem or purchase unnecessary components. On the contrary, it provides users with the opportunity to use their existing repair stand clamp and base while having the additional benefit of a motorized lift. Thus, the customer will not have to purchase an entirely new stand to see the benefits of the design, significantly reducing, for example, environmental impact of discarded stands or stand components, cost of the lift assembly, as well as risk of chronic and acute injuries to users.

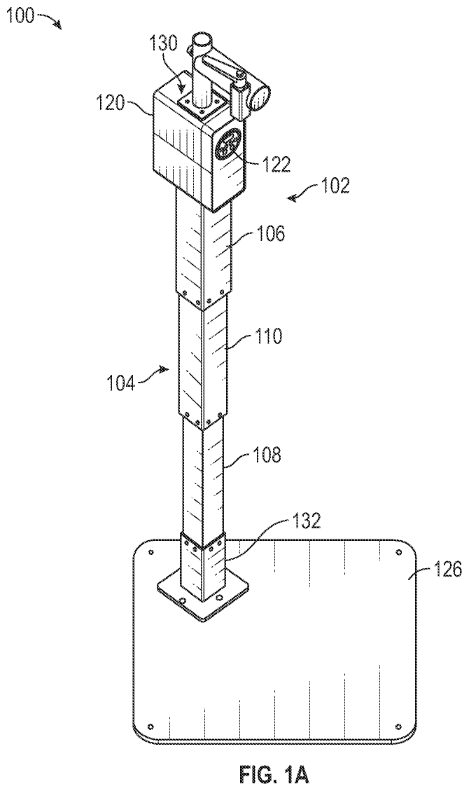

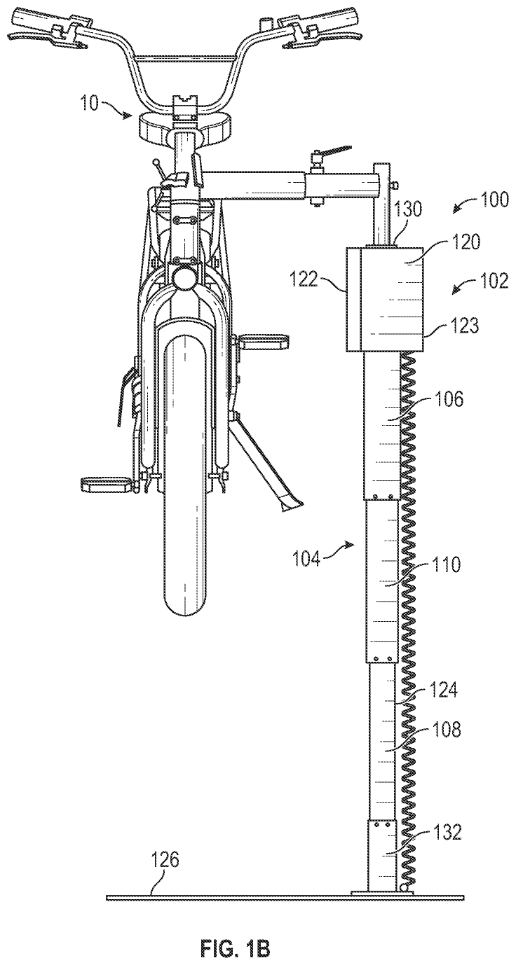

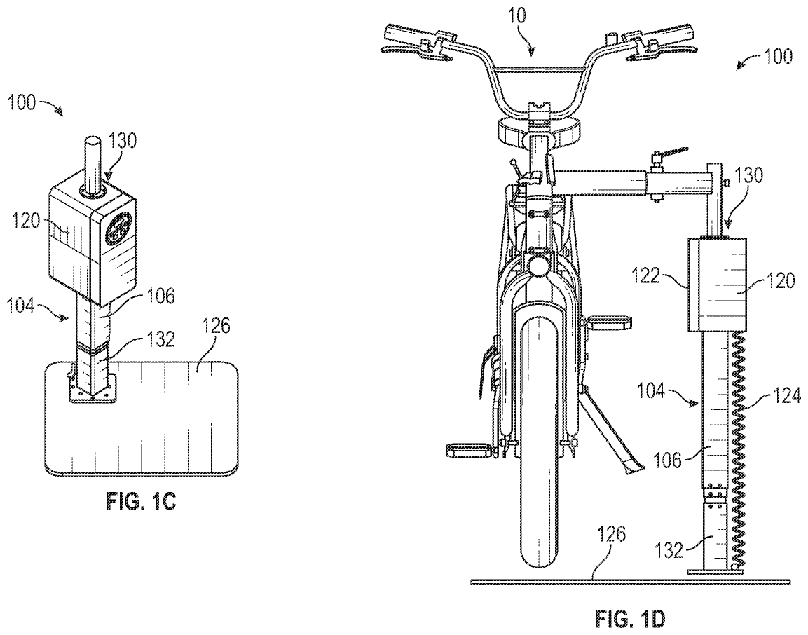

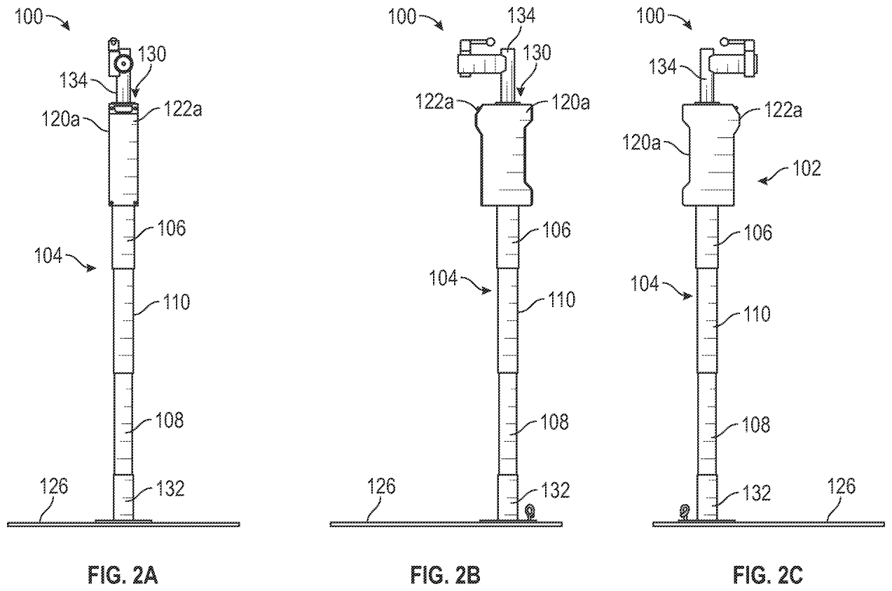

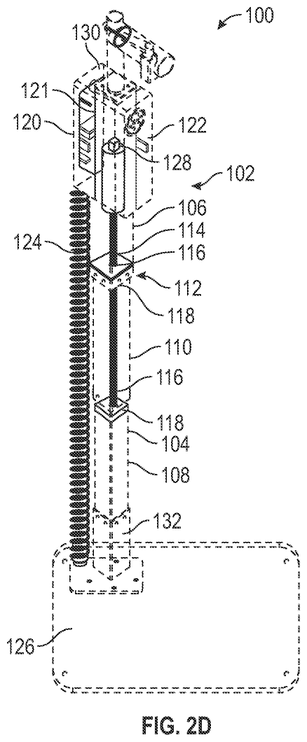

An exemplary bicycle lift assembly 100 is shown in FIGS. 1A-2D. As shown therein, a bicycle lift apparatus 102 can include a telescopic column 104 that moves between an extended position (FIGS. 1A-1B and 2A-2D) and a retracted position (FIGS. 1C-1D). The column 104 can includes at least an upper telescoping segment 106 and a lower telescoping segment 108. In some examples, the column can include one or more middle segments 110 situated between the upper and lower segments 106, 108. In operation, segments of the telescopic column 104 can vertically translate relative to one another between an extended position and a retracted position, which thereby adjusts the overall height of the column. In some examples, the telescoping segments nest within one another as the telescopic column retracts and are exposed from one another as the telescopic column extends.

In some examples, the telescoping segments of the column 104 can be inverted such that each lower segment is received within the adjacent upper segment. Thus, in such examples, the column 104 can include a largest and/or widest segment at the top of the column and the smallest and/or narrowest segment at the bottom of the column to protect the actuator within the column from moisture, contamination, or debris that may be spilled on the lift and/or that may accumulate through other means, such as from falling of debris that may occur during repair of a bicycle. In some examples, the telescoping segments of the column 104 can have a different orientation, such as having the largest segment at the bottom and the smallest at the top of the column.

In some examples, the upper segment 106 can have a top housing 120 coupled thereon for housing components of the bicycle lift apparatus 102, such as, for example, electrical components of the apparatus. In some examples, as shown in FIGS. 1A-ID, the top housing 120 is a cuboid structure formed by exterior walls and has a controller and handset 122 on a front face of the housing for controlling apparatus of the lift apparatus 102. In some examples, the top housing 120 can have a different configuration. For example, a top housing 120a is shown in FIGS. 2A-2C which includes an indentation or recessed portion in a front wall thereof and the front face includes a protrusion having the controller 122a disposed thereon.

To move the telescopic column 104 between the extended position and the retracted position, an actuator 112 can be provided within an interior space of the telescopic column segments. In some examples, the actuator 112 can be a linear actuator having a rotating screw spindle 114 that vertically extends through a threaded bore 116 of a within nuts and/or blocks 118 disposed and/or formed within one or more of column segments. For example, as shown in FIG. 2D, in some examples, the lower column segment 108 can include a nut 118 attached to or formed within an interior of a top portion the lower column segment and the upper column segment can include a nut 118 attached to or formed within an interior of a lower portion the upper column segment, which each have a bore 116 extending therethrough. In some examples, the column segment 110 and/or the top and bottom column segments 106, 108 can include additional nuts having threaded bores. In some examples, the telescopic column 104 can include just one nut 118, such as the nut 118 in the upper portion of the lower column segment 108.

In some examples, the linear actuator is a mechanism that converts rotational motion into linear motion. It can be used to drive the extension and retraction of the column 104 by converting the rotational motion of a motor into vertical motion. In some examples, the actuator 112 can be another type of actuator such as, for example, a rack and pinion actuator, pulley actuator or the like.

In some examples, the linear actuator 112 can include a motor 121 coupled to a gear train, a lead screw or ball screw (such as, e.g., the spindle 114), and one or more nuts (such as, e.g., the nuts or blocks 118 having the threaded bores 116), which are all disposed within a housing (such as, e.g., the top housing 120 and/or the telescoping segments 106, 108, 110). In some examples, the motor 121 can be an electric motor that provides rotational motion to the linear actuator 112 and receives power via a power box 123 coupled to the power cord 124. The gear train can be a set of gears that transmit the rotational motion from the motor to the lead screw or a ball screw. The lead screw or ball screw is a threaded rod that translates the rotational motion of the gear train into linear motion. The lead screw can have a threaded member configuration, while the ball screw has a more complex design that incorporates a series of ball bearings that roll along the screw threads. The nut is a component that threads onto the lead screw or ball screw and moves along the length of the screw as it rotates. The nut is typically fixed to the object that will be moved, such as a segment of the telescopic column. The housing is a protective casing that surrounds the motor, gear train, lead screw, and nut(s). When the motor rotates, the gear train transmits the rotational motion to the lead screw or ball screw, which causes the nut(s) to move along the length of the screw. This linear motion can be used to move the object that is fixed to the nut. The linear actuator can provide precise, repeatable linear motion and can be controlled with varying degrees of accuracy and speed. The specific design and performance of a linear actuator may depend on the specific application and requirements of the use.

The spindle 114 can be controlled by a bidirectional motor such that rotation of the spindle 114 by the motor in one direction extends the column 104 while rotation of the spindle 114 in the opposite direction retracts the column 104 as the spindle 114 threads through the bores 116 of the nuts 118 in the column segments. Thus, an operator can adjust the length of the column 104 by turning the motor on and controlling a direction of rotation of the motor, which in turn extends or retracts the column 104 as desired. In some examples, the operator can lock the column 104 at a given height by turning the motor off.

Alternative motor types that can be utilized with the lift apparatus and assemblies described herein include but are not limited to those described below.
Electric motor: An electric motor is a common type of motor used in lifting columns. It can be powered by direct current (DC) or alternating current (AC) and can be controlled with varying degrees of precision.
Hydraulic motor: A hydraulic motor uses pressurized fluid to generate mechanical power, which can be used to drive a lifting column. Hydraulic motors are often used in heavy-duty lifting applications.
Pneumatic motor: A pneumatic motor uses compressed air to generate mechanical power, which can be used to drive a lifting column. Pneumatic motors are often used in applications where electricity is not readily available.
Gear motor: A gear motor is a type of electric motor that incorporates a gearbox to increase torque and reduce speed. Gear motors are often used in applications that require high torque and low speed, such as lifting heavy loads.
Screw jack: A screw jack is a type of lifting mechanism that uses a threaded shaft and nut to lift or lower a load. It can be powered by a variety of motors, including electric, hydraulic, and pneumatic motors.
Chain hoist: A chain hoist is a lifting mechanism that uses a chain to lift or lower a load. It can be powered by an electric motor or manual crank.

The telescopic column 104 can be compact and the use of a programmable control box and handset 122 to control the linear actuator 112 allows for the integration of safety features and other features as further explained below. Existing height adjustable repair stands range from 89.5″ (Efficient Velo Tools EZ-Lift-https://www.efficientvelo.com/tools/ez-lift-repair-stand) to 93.2″ (Park PRS-33.2-https://www.parktool.com/en-us/product/power-lift-shop-stand-prs-33-2) tall and though they offer a greater range of movement they also require substantially higher ceilings in order to afford that range of motion. By comparison, in some examples including the spindle driven telescopic column 104 described herein, the lift apparatus 102 can have a maximum height in a range of 50 in. to 70 in. (in the extended position) and a minimum height in a range of 25 in. to 40 in. (in the retracted position), allowing the lift assembly 100 to be used in compact spaces. In some examples, the bicycle lift apparatus 102 has a maximum height of about 62 in., such as, for example, 62 in.+/−10%, 62 in.+/−5%, 62 in.+/−1%, etc. In some examples, the bicycle lift apparatus 102 has a minimum height of about 36.5 in., such as, for example, 36.5 in.+/−10%, 36.5 in.+/−5%, 36.5 in.+/−1%, etc. In some examples, a distance of extension from the minimum height to the maximum height is in a range of 20 in to 30 in. In some examples, the distance of extension is about 25.5 in, such as, for example, 25.5 in+/−10%, 25.5 in+/−5%, 25.5 in.+/−1%, etc.

In some examples, a ratio of maximum height to the minimum height is in a range of 1.5 to 2.5. In some examples, a ratio of maximum height to the minimum height is about 1.7, such as, for example 1.7+/−10%, 1.7+/−5%, 1.7+/−1%. In some examples, a ratio of the minimum height to the distance of extension is in a range of 1.2 to 1.7. In some examples, a ratio of maximum height to the minimum height is about 1.4, such as, for example 1.4+/−10%, 1.4+/−5%, 1.4+/−1%.

In some examples, the maximum height and the minimum height are measured as a distance between a top end of the upper column segment 106 and a lower end of the lower column segment 108. In some examples, the maximum height and the minimum height are measured as a distance between a clamp mount 130 on the upper column segment 106 and a base mount 132 on the lower column segment 108 (which are discussed further below).

The telescopic column 104 can provide improved safety because the linear actuator 112 can be housed entirely within and/or enclosed withing the interior of the column segments 106, 108, 110 and/or the top housing 120, and the motor can be controlled by the controller and handset 122 and/or a remote handset in communication with the controller 122. As noted above, the user can provide an input to the handset via one or more actuators (for example, one or more knobs, switches, buttons, and/or a touch screen or other user input device) which causes the controller 122 controlling the motor to rotate the spindle 114 in a clockwise or counterclockwise direction to translate the telescoping segments 106, 108, 110 of the column 104 in the desired direction. Thus, in some examples, all moving parts to the actuator 112 are enclosed whereas existing designs either have an exposed chain drive (as in e.g., Park PRS 33.2-https://www.parktool.com/en-us/product/power-lift-shop-stand-prs-33-2; Unior Electric Repair Stand-https://uniortools.com/eng/product/1693EL-electric-repair-stand) or an exposed cable connected to a counterweight and pulley (as in e.g., Efficient Velo Tools EZ-Lift-https://www.efficientvelo.com/tools/ez-lift-repair-stand). In some examples, only a power cord 124 is exposed and/or is outside of the housing (e.g., the column 104) of the lift assembly 100. In some examples, the power cord 124 can include an additional segment for connection to a power source (such as e.g., a wall outlet or a generator outlet), which can be routed through a wall or under the mats commonly used in work environments.

Advantages of the lift apparatus and assemblies 102, 100 described herein can therefore include protection of the actuator 112 from cleaning and servicing liquids, aerosols, as well dirt and other contaminants and debris which can extend the lifetime of the mechanical components and electronics and/or reduce need for repair. Further, risk of injury can be mitigated as the operator is not exposed to potentially dangerous mechanical components during operation of the lift assembly, which could otherwise catch fingers, clothes, rags, hair, tools, and/or other loose items if the actuator was exposed.

The lift apparatus and assemblies 102, 100 described herein can be utilized to move heavy loads and can potentially collide into other objects or people if the user or other persons in the vicinity of the lift are not paying adequate attention during its operation. As an additional safety measure, in some examples, the actuator 112 can include an anti-collision sensor apparatus 128 operatively connected to the motor and which can stop movement of the telescopic column 104 when triggered to prevent or minimize accidents while the lift is in motion. In some examples, when the sensor apparatus 128 detects a collision or a near collision of the column 104 and/or an object attached to the column 104 (such as, e.g., a bicycle 10) with another object or a person, the sensor apparatus 128 can automatically power off the motor to stop movement of the column 104. In some examples, the sensor apparatus 128 can be programmed to reverse the rotation of the motor such that the column 104 will move in an opposite direction from the initial direction of travel based on the detected collision or near collision. For example, if the column 104 is extending towards the extended position and were to hit or to come with a specified proximity (for example, within 1 inch) of the underside of a table that was situated to close to the lift assembly 100, the sensor apparatus 128 could detect the table bottom at the time of collision, such as with a gyroscopic sensor, or before the collision occurred, such as with a light sensor, and cause the motor to retract the column 104. In some examples, the sensor apparatus 128 can include one or more sensors. For example, the sensor apparatus 128 can include a sensor that detects an actual collision and/or a sensor that detects the presence of an obstruction (i.e., an object within a pre-defined proximity) before a collision occurs, such as those outlined below.
Voltage-based anti-collision sensor: The sensor apparatus 128 can include one or more voltage sensors to detect changes in the voltage of the lift apparatus electrical system. When the column and/or an object attached to the column comes into contact with another object, the voltage will drop due to the increased load on the motor. The system can detect this drop in voltage and can stop, slow down, or reverse the motor to prevent a collision.
Resistance-based anti-collision: The sensor apparatus 128 can include one or more resistance sensors to detect changes in the resistance of the lift apparatus electrical system. When the column and/or an object attached to the column comes into contact with another object, the resistance will increase due to the increased load on the motor. The system can detect this increase in resistance and can stop, slow down, or reverse the motor to prevent a collision.
Gyroscope-based anti-collision: The sensor apparatus 128 can include one or more gyroscopes to detect changes in the orientation of the column. When the column and/or an object attached to the column comes into contact with another object, the orientation will change due to the collision. The sensor apparatus 128 can detect this change in orientation and can stop, slow down, or reverse the motor to prevent a collision.
Laser-based anti-collision: The sensor apparatus 128 can include one or more laser sensors mounted on the lift apparatus to detect objects in the path of the column. The sensor(s) sends out a laser beam and measures the time it takes for the beam to reflect back to the sensor(s). If an object is detected in the path of the column, the sensor apparatus 128 can stop, slow down, or reverse the motor to prevent a collision.
Ultrasonic anti-collision: The sensor apparatus 128 can include one or more ultrasonic sensors mounted on the lift apparatus to detect objects in the path of the lifting column. The sensors emit high-frequency sound waves that bounce off objects and return to the sensor. If an object is detected in the movement pathway of the column, the sensor apparatus 128 can include one or more can stop, slow down, or reverse the motor to prevent a collision.
Camera-based anti-collision: The sensor apparatus 128 can include one or more cameras mounted on the lifting column to detect objects in the path of the lifting column. The cameras capture images of the surrounding environment and use computer vision algorithms to detect objects. If an object is detected in the path of the lifting column, the system can stop, slow down, or reverse the motor to prevent a collision prevent a collision.

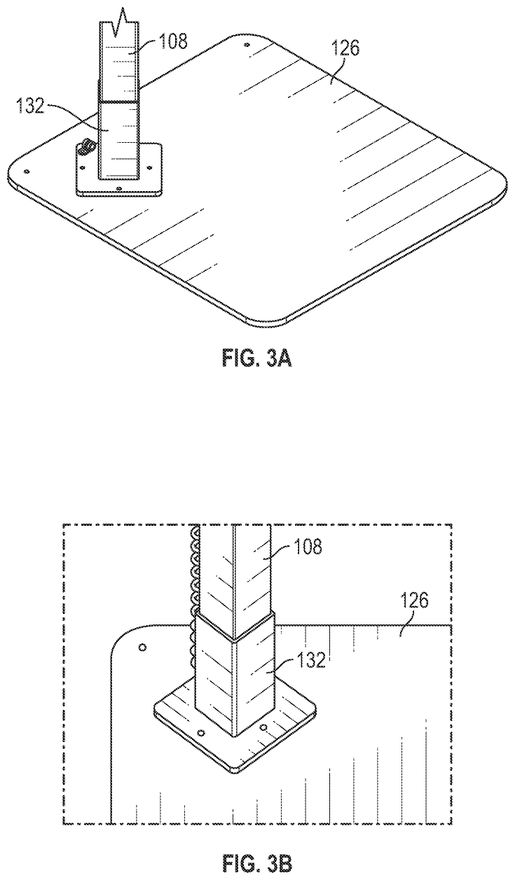

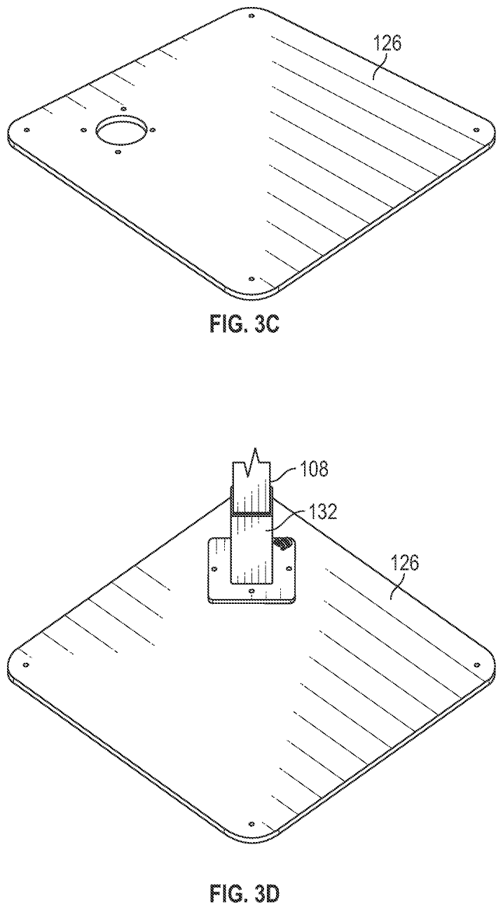

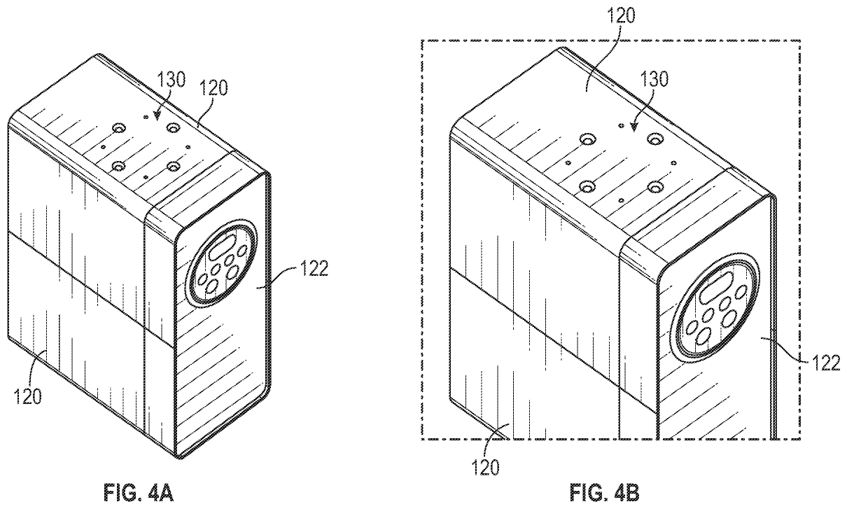

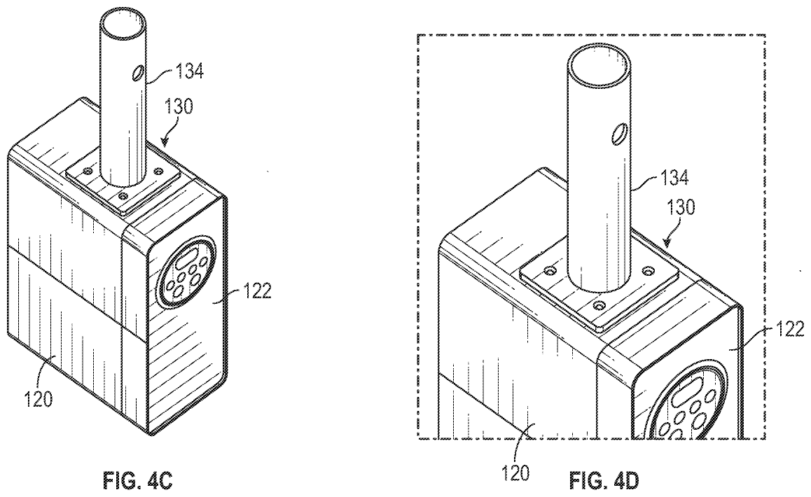

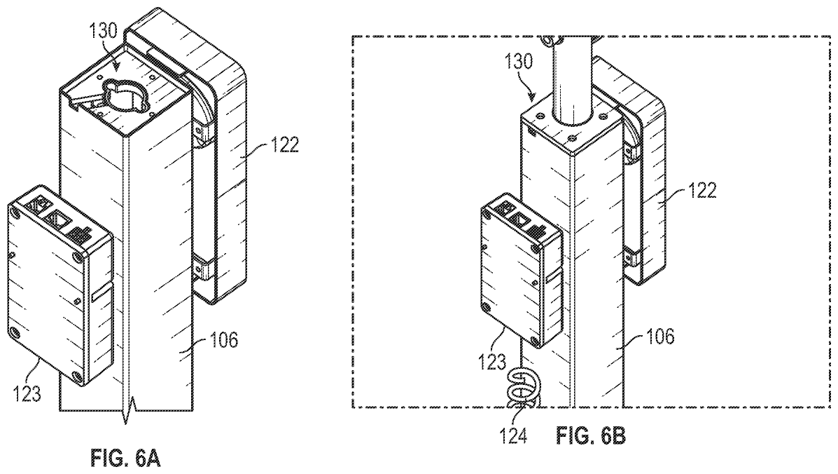

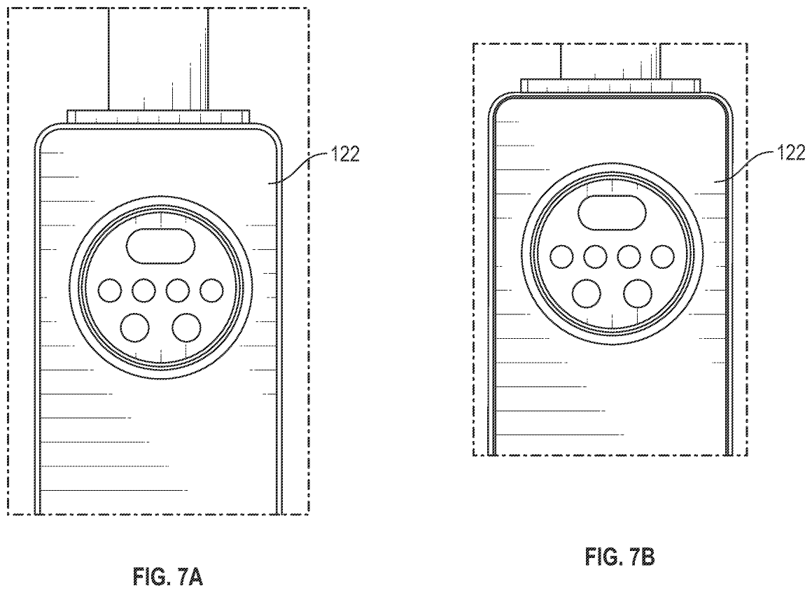

In another aspect of the lift apparatus and assemblies 102, 100 described herein, in some examples, the lift apparatus 102 can be adaptable for use with most or all existing bicycle repair stands and clamps to allow a user to retrofit their existing stand and clamps with the motorized lift apparatus 102 to form the lift assembly 100. To provide for a universal design, the top housing 120 and/or a top face of the column upper segment 106 can include a clamp mount 130 (FIGS. 4A-4B and 6A-6B) and the bottom end of the column lower segment 108 can include a base mount 132 (FIGS. 3A-3B and 3D).

In some examples, the clamp mount 130 and the base mount 132 can each have a set of apertures with different drill patterns and dimensions such that various clamps and bases corresponding with different sets of apertures within the mounts can effectively attach and/or couple to the top and bottom of the column 104.

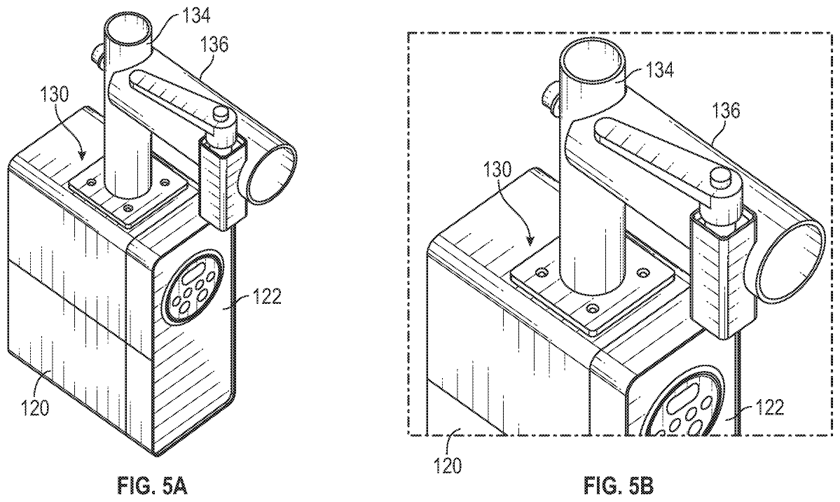

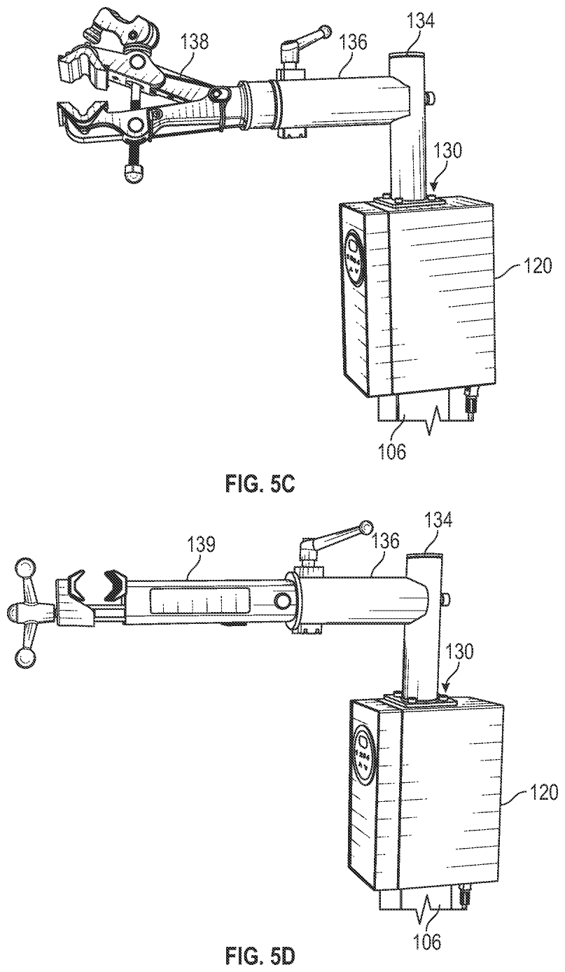

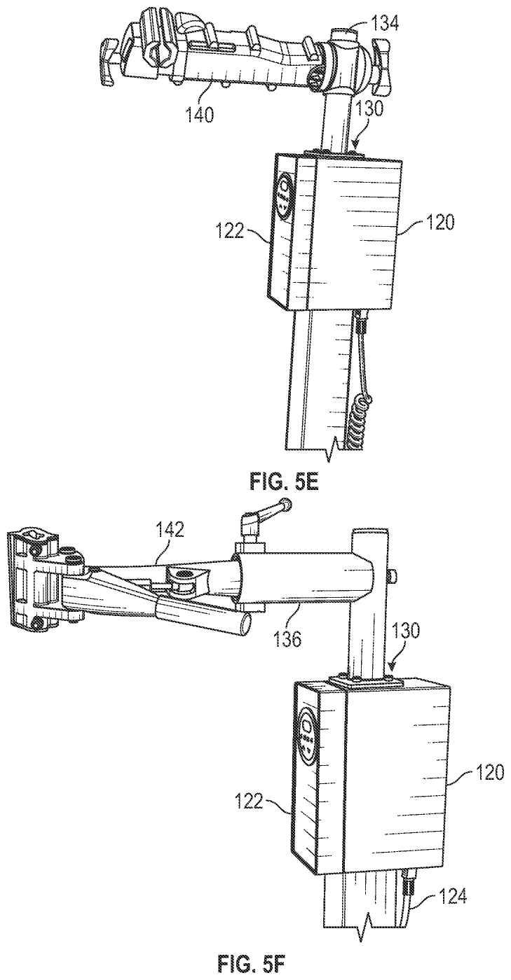

Thus, in some examples, the bicycle clamp can releasably attach to one of the clamp aperture sets with clamp fasteners and a base can releasably attach to one of the base aperture sets with base fasteners. For example, FIGS. 4C-4D show a clamp support 134 mounted and/or coupled to the clamp mount 130, and FIGS. 5A-5F show exemplary bicycle clamps (and/or clamp components) 136, 138, 139, 140, 142 coupled to the clamp support 134.

FIG. 3C shows the base 126 with the base mount 132 detached therefrom, while FIGS. 3A-3B and 3D show the base mount 132 attached to the base. It will be appreciated that a freestanding base may also be used such that a user is not required to have a wholly separate bicycle repair stand. Rather, a user may elect to use the motorized lift apparatus with a separate base plate that corresponds with a specific set of base mount apertures within the base mount. The design does not presuppose how the user could use the motorized lift apparatus but instead provides universal design that is customizable by the end user.

In some examples, the clamp mount 130 can be integral with and/or permanently attached to a native clamp support and/or bicycle clamp component. In some examples, the base mount 132 can be integral with and/or permanently attached to a native base.

Regardless of whether used with a freestanding base or retrofit to an existing stand, the motorized lift apparatus 102 can have a configuration wherein the column, the base mount and the clamp mount are aligned along a single vertical axis to provide a linearly compact and stable design. Accordingly, in some examples, a center point of the base mount 132 and a center point of the clamp mount 130 can be coaxially aligned with the central vertical axis of the column 104 that extends through the spindle 114. Thus, the telescopic column 104 is substantially vertical and does not have any cantilevered or protruding arms. This configuration can enable easier assembly, as well as greatly reducing shipping and transportation costs as compared to noncompact lifts. Alternatively, the column 104 may be offset from a base mount and/or a clamp mount.

The examples disclosed herein were chosen and described to best explain the principles of the lift apparatus, assembly, and associated methods, and their practical applications. As various modifications could be made to the exemplary lift apparatus, assemblies, and methods of use, as described above with reference to the corresponding illustrations, without departing from the scope of the disclosure. It is intended that all matter contained in the foregoing description and shown in the accompanying drawings shall be interpreted as illustrative rather than limiting. Thus, the breadth and scope of the present disclosure should not be limited by any of the above-described examples but should be defined in accordance with the following claims and their equivalents.

What is claimed is:

1. A bicycle lift apparatus comprising:
a telescopic column that is translatable between an extended position and a retracted position, wherein the telescopic column comprises a plurality of segments including an upper segment and a lower segment, wherein the upper segment includes a top end portion and the lower segment includes a bottom end portion;
a clamp mount on the top end portion of the upper segment, wherein the clamp mount is configured for releasable coupling of a bicycle clamp thereto;
a base mount on the bottom end portion of the lower segment, wherein the base mount is configured for releasable coupling of a lift base thereto; and
an actuator disposed in an interior of the telescopic column, wherein the actuator comprises a spindle and a motor, wherein the spindle axially extends through the telescopic column and is threadedly engaged with one or more threaded bores disposed within the telescopic column, wherein the motor is operatively engaged with the spindle to cause rotation thereof which results in in translation of the telescopic column between the extended position and the retracted position, wherein rotation of the spindle in a first direction results in translation of the telescopic column toward the extended position, and wherein rotation of the spindle in a second, opposing direction results in translation of the telescopic column toward the retracted position.

2. The bicycle lift apparatus of claim 1, wherein the actuator is configured to, when the motor is off, prevent translation of the upper segment relative to the lower segment and maintain the telescopic column at a selected height between the top end and the bottom end.

3. The bicycle lift apparatus of claim 1, wherein the upper segment is sized and shaped to receive the lower segment when the telescopic column is in the retracted position.

4. The bicycle lift apparatus of claim 1, wherein upper segment has a first width and the lower segment has a second width, wherein the first width is greater than the second width.

5. The bicycle lift apparatus of claim 4, wherein the telescopic column further comprises a middle segment disposed between the upper segment and the lower segment, wherein upper segment is sized and shaped to receive the middle segment and the middle segment is sized and shaped to receive the lower segment.

6. The bicycle lift apparatus of claim 5, wherein middle segment has a third width, wherein the third width is less the first width and is greater than the second width.

7. The bicycle lift apparatus of claim 1, wherein the actuator is enclosed within the interior of the telescopic column.

8. The bicycle lift apparatus of claim 1, wherein the telescopic column is translatable between a maximum height and a minimum height, and wherein a ratio of the maximum height to the minimum height is in a range of 1.5 to 2.5.

9. The bicycle lift apparatus of claim 8, wherein the ratio of the maximum height to the minimum height is about 1.7.

10. The bicycle lift apparatus of claim 1, wherein the telescopic column is translatable between a maximum height and a minimum height, and wherein the maximum height is in a range of 50 in. to 70 in. and the minimum height is in a range of 25 in. to 40 in.

11. The bicycle lift apparatus of claim 1, wherein the telescopic column is translatable between a maximum height and a minimum height, and wherein the maximum height is about 62 in. and the minimum height is about 36.5 in.

12. The bicycle lift apparatus of claim 1, wherein the telescopic column is translatable between a maximum height and a minimum height, and wherein a ratio between the minimum height and a distance of extension between the minimum height and the maximum height is in a range of 1.2 to 1.7.

13. The bicycle lift apparatus of claim 1, wherein each of the clamp mount comprises a first center point and the base mount comprises a second center point, and wherein the first and second center points are coaxially aligned with a vertical axis of the spindle.

14. The bicycle lift apparatus of claim 1, further comprising one or more anti-collision sensors operatively coupled to the motor, wherein the one or more anti-collision sensors are each configured to detect at least one of a collision or a near collision between the telescopic column and an object, and wherein the one or more anti-collision sensors are configured to, based at least on detection of the collision or the near collision, cause at least one of stopping of the motor or operation of the motor in a reverse direction relative to an initial direction.

15. A bicycle lift apparatus comprising:
a telescopic column that is translatable between an extended position and a retracted position, wherein the telescopic column comprises a plurality of segments including an upper segment and a lower segment, wherein the upper segment includes a top end portion and the lower segment includes a bottom end portion, wherein the upper segment vertically translates relative to the lower segment when the telescopic column moves between the extended position and the retracted position;
a clamp mount on the top end portion of the upper segment, wherein the clamp mount is configured for releasable coupling of a bicycle clamp thereto;
a base mount on the bottom end portion of the lower segment, wherein the base mount is configured for releasable coupling of a lift base thereto;
an actuator disposed in an interior of the telescopic column, wherein the actuator is operatively engaged with the telescopic column to cause the translation thereof between the extended position and the retracted position; and
one or more anti-collision sensors operatively coupled to the actuator, wherein the one or more anti-collision sensors are each configured to detect at least one of a collision or a near collision between the telescopic column and an object;
wherein the one or more anti-collision sensors are configured to, based at least on detection of the collision or the near collision, cause at least one of stopping of translation of the telescopic column or translation of the telescopic column in a reverse direction relative to an initial direction.

16. The bicycle lift apparatus of claim 15, wherein the one or more anti-collision sensors comprise a voltage-based sensor.

17. The bicycle lift apparatus of claim 15, wherein the one or more anti-collision sensors comprise a resistance sensor.

18. The bicycle lift apparatus of claim 15, wherein the one or more anti-collision sensors comprise a laser sensor.

19. The bicycle lift apparatus of claim 15, wherein the one or more anti-collision sensors comprise an ultrasonic sensor.

20. A bicycle lift apparatus comprising:
a telescopic column that is translatable between an extended position and a retracted position, wherein the telescopic column comprises a plurality of segments including an upper segment, one or more middle segments, and a lower segment, wherein the upper segment includes a top end portion and the lower segment includes a bottom end portion, wherein the upper segment is sized and shaped to receive the one or more middle segments, and the one or more middle segments are sized and shaped to receive the lower segment;
a clamp mount on the top end portion of the upper segment;
a base mount on the bottom end portion of the lower segment, wherein the base mount is configured for releasable coupling of a lift base thereto; and
an actuator disposed in an interior of the telescopic column, wherein the actuator comprises a spindle and a motor, wherein the spindle axially extends through the telescopic column and is threadedly engaged with one or more threaded bores disposed within the telescopic column, wherein the motor is operatively engaged with the spindle to cause rotation thereof which results in in translation of the telescopic column between the extended position and the retracted position, wherein rotation of the spindle in a first direction results in translation of the telescopic column toward the extended position, and wherein rotation of the spindle in a second, opposing direction results in translation of the telescopic column toward the retracted position;
wherein the telescopic column is translatable between a maximum height and a minimum height, and wherein the maximum height is in a range of 50 in. to 70 in. and the minimum height is in a range of 25 in. to 40 in.
